(19) United States
(12) Patent Application Publication
(10) Pub. No.: US 2026/0024528 A1
(43) Pub. Date: Jan. 22, 2026

(54) WAGER TABLE ASSEMBLY AND SYSTEM

(71) Applicant: Casino AI LLC, Thornton, CO (US)

(72) Inventor: Jeremy Webb, Thornton, CO (US)

(73) Assignee: Casino AI LLC, Thornton, CO (US)

(21) Appl. No.: 19/275,598

(22) Filed: Jul. 21, 2025

Related U.S. Application Data
(60) Provisional application No. 63/674,164, filed on Jul. 22, 2024.

(51) Int. Cl. G10L 15/22; G06Q 30/015; G06V 40/16; G07F 17/32; G10L 13/08; G10L 15/00; G10L 15/08

(52) U.S. Cl. CPC G10L 15/22; G06Q 30/015; G06V 40/174; G07F 17/3288; G10L 13/086; G10L 15/005; G10L 15/083

(57) ABSTRACT

At least some embodiments of the present disclosure are directed to systems and methods for providing interactive wager services. A method includes receiving a voice input in a first language via a first communication device, identifying the first language in the voice input, generating an output in a second language by applying a machine learning model to the voice input to translate the voice input from the first language to the second language. In some instances, a method includes generating an order and/or a customer service item by applying a machine learning model to a user query.

### CROSS REFERENCE TO RELATED APPLICATION

This application claims priority to Provisional Application No. 63/674,164, filed Jul. 22, 2024, which is herein incorporated by reference in its entirety.

### TECHNICAL FIELD

The present disclosure relates to wager tables, wager table assemblies, and wager table systems. More specifically, the present disclosure relates to artificial intelligence (AI) enhanced interactive wager tables, wager table assemblies and systems.

### BACKGROUND

In some examples, in a casino setting, wager tables like blackjack are operated with a structured and immersive approach designed to enhance both gameplay and guest experience. In some examples, each table is staffed by a trained dealer who manages the game, enforces rules, handles chips and payouts, and facilitate communications between players. In some examples, while playing, guests are regularly offered complimentary drinks by cocktail servers, who make rounds to take drink or food orders, wait for them to be prepared at the bar, and then return to deliver them to the players. In some examples, a casino host is assigned to certain players, assisting with room bookings, dinner reservations, show tickets, transportation, and/or other players' personalized needs. In some examples, a casino host also act as liaisons between the casino and the players to advocate for the players and mediate solutions.

### SUMMARY

As recited in examples, Example 1 is a wager table management system includes one or more wager communication system. Each wager communication system is couplable to a wager table and includes a first communication device couplable to the wager table, and a second communication device couplable to the wager table and communicatively coupled to the first communication device. The system further includes one or more memories having instructions stored thereon, and one or more processors configured to execute the instructions and perform operations including receiving a voice input in a first language via the first communication device, and generating an output in a second language by applying a first machine learning model to the voice input to translate the voice input from the first language to the second language.

Example 2 is a method of providing interactive wager services. The method includes receiving a voice input in a first language via a first communication device; identifying the first language in the voice input; and generating an output in a second language by applying a first machine learning model to the voice input to translate the voice input from the first language to the second language.

Example 3 is a method of generating an order. The method includes receiving a user query indicative of a user order via the first communication device; identifying the first language of the user query; generating an order applying a third machine learning model to the user query; and causing to present the order at a user interface.

Example 4 is a method of generating a customer service item. The method includes receiving a user query indicative of a customer service item via the first communication device; identifying the first language of the user query; generating the customer service item by applying a fourth machine learning model to the user query; and causing to deliver the customer service item to a user interface.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

FIG. 1 is a block diagram of an example of a wager table management system for providing interactive services at wager tables, in accordance with embodiments of the subject matter of the disclosure.

FIG. 2 depicts a block diagram of an example of a wager table assembly, in accordance with embodiments of the subject matter of the disclosure.

FIG. 3 is a block diagram of an example communication device, in accordance with embodiments of the subject matter of the disclosure.

FIG. 4 is a block diagram of an example method for establishing communication between communication devices at a wager table, in accordance with embodiments of the subject matter of the disclosure.

FIG. 5 is a block diagram of an example of a wager table management system, in accordance with embodiments of the subject matter of the disclosure.

FIG. 6 is an example flow diagram depicting an illustrative method of providing interactive services for players at wager tables, in accordance with some embodiments of the present disclosure.

FIG. 7 is a simplified block diagram of a computing device, with which aspects of the present disclosure may be practiced.

While the disclosure is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

As the terms are used herein with respect to measurements (e.g., dimensions, characteristics, attributes, components, etc.), and ranges thereof, of tangible things (e.g., products, inventory, etc.) and/or intangible things (e.g., data, electronic representations of currency, accounts, information, portions of things (e.g., percentages, fractions), calculations, data models, dynamic system models, algorithms, parameters, etc.), “about” and “approximately” may be used, interchangeably, to refer to a measurement that includes the stated measurement and that also includes any measurements that are reasonably close to the stated measurement, but that may differ by a reasonably small amount such as will be understood, and readily ascertained, by individuals having ordinary skill in the relevant arts to be attributable to measurement error; differences in measurement and/or manufacturing equipment calibration; human error in reading and/or setting measurements; adjustments made to optimize performance and/or structural parameters in view of other measurements (e.g., measurements associated with other things); particular implementation scenarios; imprecise adjustment and/or manipulation of things, settings, and/or measurements by a person, a computing device, and/or a machine; system tolerances; control loops; machine-learning; foreseeable variations (e.g., statistically insignificant variations, chaotic variations, system and/or model instabilities, etc.); preferences; and/or the like.

Although illustrative methods may be represented by one or more drawings (e.g., flow diagrams, communication flows, etc.), the drawings should not be interpreted as implying any requirement of, or particular order among or between, various steps disclosed herein. However, certain some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items, and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information.

The present disclosure describes wager tables, wager table assemblies, wager table management systems, and systems and methods for providing interactive services for users (e.g., players, dealers, etc.) at wager tables. According to certain embodiments, a method includes receiving a voice input in a first language via a first communication device; identifying the first language in the voice input; and generating an output in a second language by applying a first machine learning model to the voice input to translate the voice input from the first language to the second language. According to some embodiments, a method includes receiving a user query indicative of a user order via the first communication device; identifying the first language of the user query; generating an order applying a third machine learning model to the user query; and causing to present the order at a user interface. According to some embodiments, a method includes receiving a user query indicative of a customer service item via the first communication device; identifying the first language of the user query; generating the customer service item by applying a fourth machine learning model to the user query; and causing to deliver the customer service item to a user interface.

According to some embodiments, systems and methods described herein use one or more computing models. In certain embodiments, a model, also referred to as a computing model, includes a model to process data. A model includes, for example, an artificial intelligence (AI) model, a machine learning (ML) model, a deep learning (DL) model, an image processing model, an algorithm, a rule, other computing models, and/or a combination thereof.

In some embodiments, a generative AI (artificial intelligence) model includes training data embedded in the model. In certain embodiments, a generative AI model is a type of AI model that can be used to produce various type of content, such as text, images, videos, audio, 3D (three-dimensional) data, 3D models, and/or the like. In some embodiments, a language model or a large language model (LLM), which is a type of generative AI model, includes content and training data embedded in the model.

In some embodiments, a machine learning (ML) model is a language model (“LM”) that may include an algorithm, rule, model, and/or other programmatic instructions that can predict the probability of a sequence of words. In some embodiments, a language model may, given a starting text string (e.g., one or more words), predict the next word in the sequence. In certain embodiments, a language model may calculate the probability of different word combinations based on the patterns learned during training (based on a set of text data from books, articles, websites, audio files, etc.). In some embodiments, a language model may generate many combinations of one or more next words (and/or sentences) that are coherent and contextually relevant. In certain embodiments, a language model can be an advanced artificial intelligence algorithm that has been trained to understand, generate, and manipulate language. In some embodiments, a language model can be useful for natural language processing, including receiving natural language prompts and providing natural language responses based on the text on which the model is trained. In certain embodiments, a language model may include an n-gram, exponential, positional, neural network, and/or other type of model.

In certain embodiments, a machine learning model is a large language model (LLM), which has been trained on a larger data set and has a larger number of parameters (e.g., billions of parameters) compared to a regular language model. In certain embodiments, an LLM can understand more complex textual inputs and generate more coherent responses due to its extensive training. In certain embodiments, an LLM can use a transformer architecture that is a deep learning architecture using an attention mechanism (e.g., which inputs deserve more attention than others in certain cases). In some embodiments, a language model includes an autoregressive language model, such as a Generative Pre-trained Transformer 3 (GPT-3) model, a GPT 3.5-turbo model, a Claude model, a command-xlang model, a bidirectional encoder representation from transformers (BERT) model, a pathways language model (PaLM) 2, and/or the like. A prompt can be provided for processing by the LLM, which thus generates a response, a recommendation, or a content accordingly.

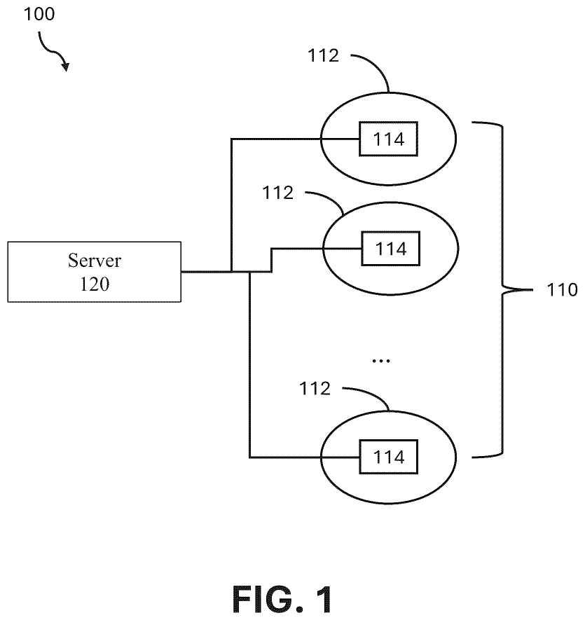

FIG. 1 illustrates a wager table management system 100 for providing interactive services for players at wager tables, in accordance with embodiments of the subject matter of the disclosure. The wager table management system 100 includes one or more wager table assemblies 110. Each wager table assembly 110 includes a wager table 112 and a wager communication system 114 associated with a respective wager table 112. The respective wager communication systems 114 are coupled to a server 120, which can be separate from the wager tables 112.

In some embodiments, the wager communication system 114 can be packaged using an enclosure (not shown) which can be mechanically coupled to a tabletop of the respective wager table 112. In some examples, an enclosure can be a 3D-printed enclosure.

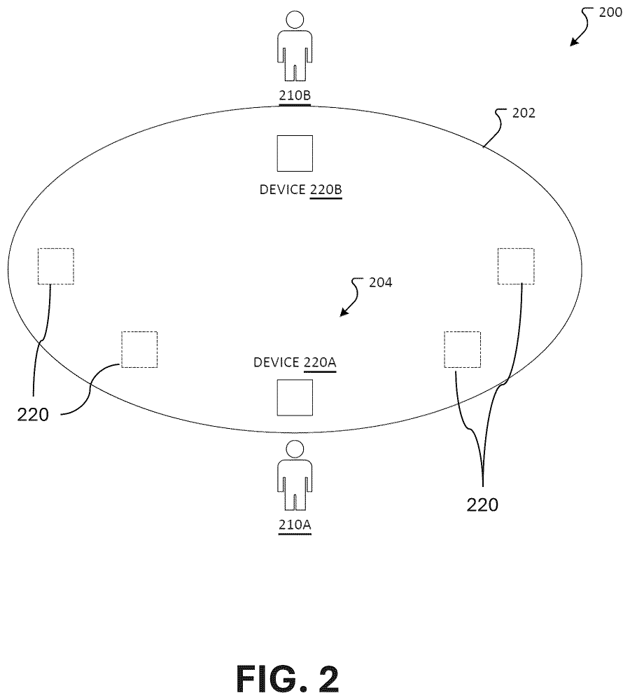

FIG. 2 depicts a block diagram of an example of a wager table assembly 200, in accordance with embodiments of the subject matter of the disclosure. The wager table assembly 200 can be or include the wager table assembly 110 of FIG. 1. The wager table assembly 200 includes a wager table 202 and a wager communication system 204. The wager communication system 204 includes at least two communication devices 220. Each communication device 220 is associated with a user 210 (e.g., a first player 210A, a second player 210B, etc.). The communication devices 220 of the wager communication system 204 are communicatively coupled to each other. For example, the communication devices 220 may be communicatively coupled to each other via a network (e.g., a wired or wireless local area network (LAN), a wired or wireless wide area network (WAN), and/or the Internet). In some embodiments, the communication devices 220 may be directly coupled to each other via a wire.

For example, the communication device 220 may be, but is not limited to, a computer, a notebook, a laptop, a mobile device, a smartphone, a tablet, a portable device, a wearable device, or any other suitable communication device that is capable of translating audio input to a desired language. In some embodiments, the communication device 220 can be coupled to the server 120 in FIG. 1. For example, the server 120 may be any suitable computing device that is capable of communicating with the communication device 220.

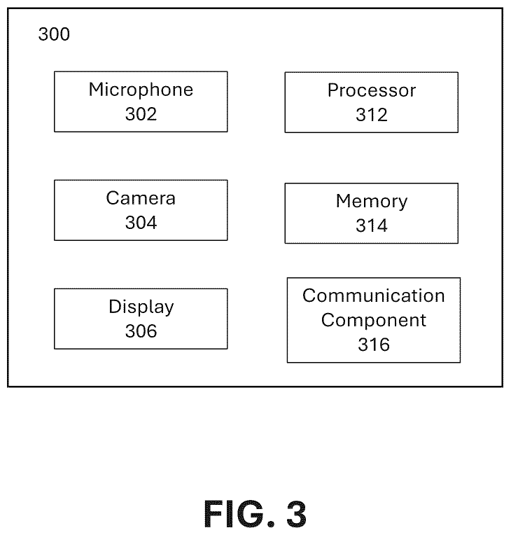

FIG. 3 is a block diagram of an example communication device 300, in accordance with embodiments of the subject matter of the disclosure. The communication device 300 may be, or may be similar to, the communication device 220 depicted in FIG. 2 and may be used in the system 100 of FIG. 1 and the wager table assembly 200 of FIG. 2. One or more blocks or components of communication device 300 are optional and/or can be modified by one or more components of other instances described herein. Additionally, one or more blocks or components of other instances described herein may be added to the communication device 300. According to some embodiments, the example communication device 300 include one or more sensors (e.g., an audio sensor such as a microphone, an image sensor such as a camera, etc.) to capture user data that can be processed, e.g., by a processor 312 of the communication device 300, and one or more input/output devices (e.g., a display 306) to display a representation of outputs.

In some embodiments, the communication device 300 includes a microphone 302 to detect a variety of physiological and environmental sounds including a voice input from a user (e.g., a player). For example, the microphone 302 can detect a voice-activated request, user response, or prompt from the user in a vocalized natural language (e.g., English, Japanese, Spanish, and the like). In some examples, the microphone 302 may also detect environmental sounds or noise in a noisy environment. In some embodiments, the microphone 302 of the communication device 300 includes a directional microphone to pick up a voice input from certain user(s).

In some embodiments, the communication device 300 includes a camera 304 (e.g., an image sensor) to detect facial expression and/or lip movement data of a user (e.g., a player). The camera 304 can be positioned to capture the player's face images. In some examples, the camera 304 may include one or more infrared cameras and/or depth-sensing cameras. In some embodiments, the camera 304 continuously captures video frames (images) at a set frame rate (e.g., 30 fps). Each frame is a still image that can be analyzed individually or as part of a sequence.

The communication device 300 further includes a memory 314 to store sensing data from the sensors of the communication device 300. In some embodiments, the communication device 300 can use a rolling buffer by allocating a block of memory as a buffer that operates in a circular fashion. For example, when the sensors generate new sensing data, the new sensing data overwrites the relatively older data in the rolling buffer. In some embodiments, the memory 314 can store data related to local machine learning models that can be applied by the communication device 300.

In some embodiments, the communication device 300 further includes a communication component 316 configured to connect to an external device (e.g., the server 120 shown in FIG. 1, other communication device 220 at the same wager table 202 as shown in FIG. 2). In some examples, the sensing data from one or more of the sensors of the communication device 300 can be transmitted to a server and/or another communication device.

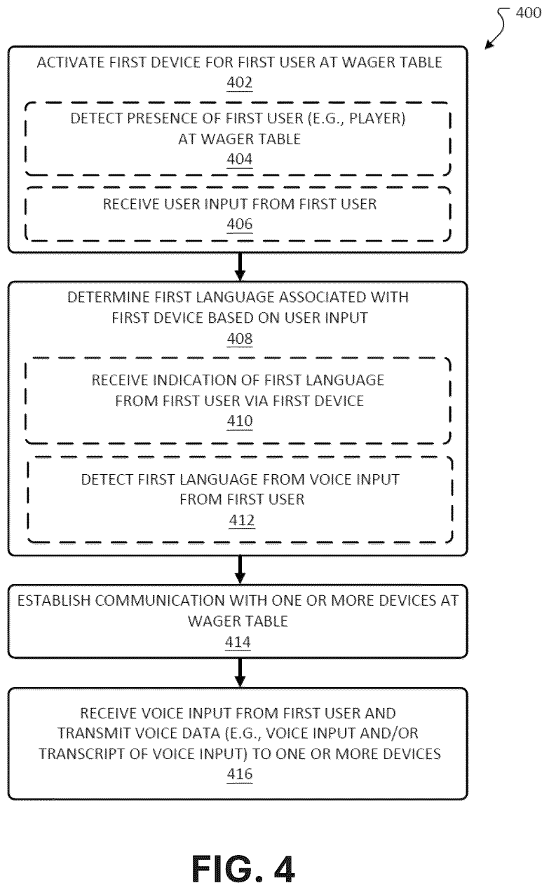

Referring now to FIG. 4, a method 400 for establishing communication between communication devices at a wager table in accordance with examples of the present disclosure is provided. A general order for the steps of the method 400 is shown in FIG. 4. The method 400 may include more or fewer steps or may arrange the order of the steps differently than those shown in FIG. 4. In the illustrative aspect, the method 400 is performed by a communication device (e.g., the communication device 220 in FIG. 2, the communication device 300 in FIG. 3) of a user (e.g., a first user 210A in FIG. 2). However, it should be appreciated that one or more steps of the method 400 may be performed by another device (e.g., a server such as the server 120 in FIG. 1).

The method 400 can be executed as a set of computer-executable instructions executed by a computer system and encoded or stored on a computer readable medium. Further, the method 400 can be performed by gates or circuits associated with a processor, Application Specific Integrated Circuit (ASIC), a field programmable gate array (FPGA), a system on chip (SOC), or other hardware device. Hereinafter, the method 400 shall be explained with reference to the systems, components, modules, software, data structures, user interfaces, etc. described in conjunction with FIGS. 1-2.

The method 400 starts at operation 402. At operation 402, the first communication device 220A is activated at the wager table. For example, in some embodiments, the first communication device 220A may be activated in response to detecting a presence of a first user at the wager table, as indicated in operation 404. In certain embodiments, the first communication device 220A may be activated in response to an input received from a first user at the wager table, as indicated in operation 406. For example, the input may be a voice input or a touch input on a user interface (e.g., a display screen) of the first communication device 220A. The activating the first communication device 220A may include turning on the power of the first communication device 220A, waking up the first communication device 220A from sleep mode to turn on a display screen of the first communication device 220A, or otherwise setting up the first communication device 220A to be ready to receive an input from the first user. It should be appreciated that, in some embodiments, the activated first communication device 220A may provide instructions on the display screen of the first communication device 220A querying the first user to select a language for the first user and/or to speak in order to detect the language of the first user.

At operation 408, the first communication device 220A determines the language (e.g., the first language) of the first user based on the user input and setting the first communication device 220A. To do so, the first communication device 220A may receive an indication of the first language from the first user via the user interface of the first communication device 220A, as indicated in operation 410. Additionally, or alternatively, the first communication device 220A may detect the first language from a voice input received from the first user, as indicated in operation 412.

At operation 414, the first communication device 220A establishes communication with one or more devices at the wager table. As described above, the devices 220 are configured to facilitate communications between people at the wager table who may not speak the same language. For example, the first communication device 220A is communicatively coupled to a second communication device 220B of a dealer at the wager table. Additionally, in some embodiments, the first communication device 220A may be communicatively coupled to multiple communication devices 220 for communicating with a dealer and other players at the wager table. It should be appreciated that the operation 414 may be performed before, during, or after performing operations 402-412.

At operation 416, the first communication device 220A receives a voice input from the first user and transmit voice data to the one or more communication devices 220. The voice data may be the voice input and/or a transcript of the voice input. For example, the first communication device 220A may receive a voice input from the first user and transmit the voice input to the one or more devices. Alternatively, the first communication device 220A may receive a voice input from the first user 210A, transcribe the voice input, and transmit the transcript of the voice input to the one or more communication devices 220. In some embodiments, the first communication device 220A may receive a voice input from the first user, transcribe the voice input, and transmit the voice input with the transcript of the voice input (e.g., as metadata) to communication devices 220. Additionally, or alternatively, the voice data may further include the indication of the first language. As described further below, the voice data is translated into another language at the respective communication device 220 in accordance with the language set for the respective communication device 220.

In some embodiments, the second communication device 220B receives voice data from the first communication device 220A of the wager table 202, which is communicatively coupled to the second communication device 220B. The second communication device 220B determines the first language associated with the voice data. As described above, the voice data received from the first communication device 220A may include a voice input and/or a transcript of the voice input. The voice data may further include an indication of the first language.

In some embodiments, the second communication device 220B identifies a second language associated with the second user 210B, and generates an output in the second language associated with the second user 210B by translating the voice data from the first language to the second language.

In some embodiments, the second communication device 220B provides the output to the second user 210B. For example, the output may be a voice data that is played to the second user 210B via an audio (e.g., a speaker, a headset, an earphone, etc.) associated with the second communication device 220B. Additionally, or alternatively, the output may be a text that is displayed on the display screen of the second communication device 220B.

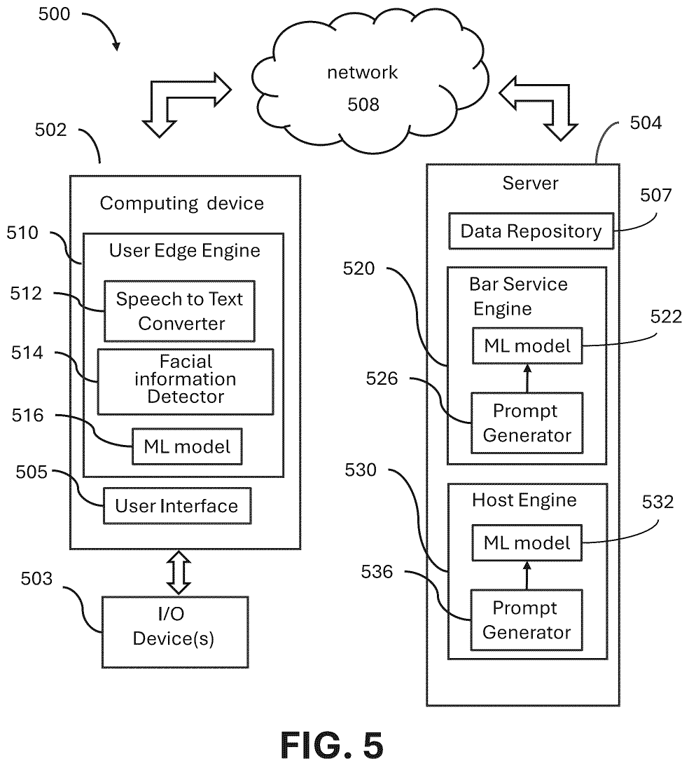

FIG. 5 is a block diagram of a wager table management system 500, in accordance with embodiments of the subject matter of the disclosure. According to some embodiments, the system 500 includes a computing device 502 and a server 504 connected by a communication network 508. The computing device 502 may be, or may be similar to the communication device 220 in FIG. 2, and the communication device 300 in FIG. 3. The server 504 may be, or may be similar to the server 120 in FIG. 1.

In certain embodiments, the computing device 502 includes a user edge engine or processor 510 configured to receive query information associated with a user (e.g., a player) from one or more input/output devices 503 to generate outputs.

In some embodiments, the computing device 502 further includes a user interface (UI) engine 505 which can instruct an input/output device 503 (e.g., a display) to display a representation of the generated outputs.

In some embodiment, the user interface (UI) engine 505 solicitates a user to indicate or confirm one or more preferred languages. In some embodiments, the UI engine 505 can provide various user interaction modes. In an example, the UI engine 505 can apply gesture recognition processes to allow users to interact with the system 500 through hand or body gestures. In an example, the UI engine 505 can allow the system 500 to recognize and respond to user's vocalized commands/instructions directly, to facilitate a hands-free operation. In some embodiments, the UI engine 505 can provide multi-modal feedback to a user. In some examples, the UI engine 505 can integrate advanced visual (e.g., LED indicators, embedded screens) and auditory cues (e.g., varying tones or alerts).

In some embodiment, the input/output devices 503 include, for example, a microphone of a communication device, a camera of a communication device, a display of a communication device, etc. It is to be understood that the input/output devices 503 may include other devices associated with a wager table. The input/output devices 503 can receive or detect user data associated with a user (e.g., a player).

In some embodiments, the user edge engine or processor 510 includes a speech-to-text (STT) converter 512 configured to receive an audio input including a vocalized language and convert the vocalized language captured through the audio input into texts. The speech-to-text (STT) converter 512 includes, for example, a speech-to-text (STT) application programming interface (API).

In some embodiments, the speech-to-text (STT) converter 512 receives a user vocalized query and apply a multilingual speech recognition model to identify a language of the user vocalized query. In some embodiments, the multilingual speech recognition model can be customized and/or trained for specific use cases of a wager table to accurately transcribe vocalized words into text, including support for various languages and dialects. In some embodiments, the user edge engine or processor 510 can apply a machine learning model 516 to the audio input to translate the voice input from the first language to the second language.

In some embodiments, the user edge engine or processor 510 includes a facial information detector 514 to receive facial information detection data and generate a facial expression recognition output and/or a visual speech recognition output based on the facial information detection data.

In some embodiments, a camera captures real-time facial image data of a user, which is then preprocessed to enhance quality, including, for example, resizing, normalization, noise reduction, etc. The facial information detector 514 receives facial image data from the camera and applies a machine learning model to generate a facial expression recognition output and/or a visual speech recognition output. In some examples, the machine learning model includes a facial detection algorithm to identify and isolate the face region from the image. When the face is detected, the machine learning model can generate a facial landmark detection model by extracting key points such as eyes, eyebrows, nose, mouth, and jawline. The machine learning model analyzes the landmarks to determine facial muscle movements and configurations. In some embodiments, the machine learning model includes a trained deep learning model (e.g., a CNN or a transformer-based model) for facial expression recognition by classifying the expression into categories such as happy, sad, angry, etc., based on the spatial arrangement of facial features. In some embodiments, the machine learning model can be applied to a sequence of frames of facial images for visual speech recognition (e.g., lip reading) by using models to interpret mouth movements and map them to phonemes or words. The facial information detector 514 outputs the recognized facial expression and/or the interpreted speech content, which can be combined with the outputs from speech-to-text (STT) converter 512 for determine the speech content from certain user at a wager table.

In some embodiments, the determined speech content from a first communication device can be transmitted to a second communication device coupled to the same wager table. The second communication device can translate the speech content from a first language associated with a first user to a second language associated with a second user. In some embodiments, a user edge engine or processor of the second communication device includes a text-to-speech (TTS) converter configured to receive the determined speech content from the first communication device and convert at least a portion of the speech content to a voice data in the identified second language before providing the speech content to the second user via an audio device (e.g., a speaker, a headset, an earphone, etc.) of the second communication device.

In some embodiments, the server 504 includes a bar service engine 520 configured to receive the user query from the user interface (UI) engine 505 and/or the speech-to-text (STT) converter 512 and generate an order by applying a machine learning (ML) model 522 to the received user query and relevant data a data repository 507. In some embodiments, the data repository 507 can store data related to machine learning models, user historical data, secure device authentication, encryption, etc. In some examples, the bar service engine 520 can be coupled to an analytics and operational intelligence dashboard of the system 500 to further analyze and/or present the output of the bar service engine 520. In some examples, the order can include a drink order, a food order, etc.

In some examples, a drink order generated by the bar service engine 520 can be delivered to a user interface associated with a bar (e.g., to display at a bar kitchen display screen), and a generated food order can be delivered to a user interface associated with a restaurant. For example, a notification can be delivered to a bartender regarding a user order, e.g., what to make, what order to put it on the tray, etc. A waitress can deliver rounds of drinks instead of having to make a round to ask for drinks then come back and wait for the drinks to be made then go back and deliver. This can double the efficiency of the cocktail waitress staff. Similarly, players can order food delivered to the wager tables.

In some embodiments, the bar service engine 520 includes a prompt generator engine 526 configured to generate an order prompt based at least in part on the received user query. In some embodiments, the prompt generator engine 526 can preprocess the received user query by, for example, removing any noise or irrelevant information that may interfere with interpretation by the machine learning model. In some embodiments, the prompt generator engine 526 can apply natural language processing (NLP) and/or natural language understanding (NLU) techniques or related models to extract key information from the user query to determine the task or intent behind the user's query. Based on the identified task or intent, the prompt generator engine 526 can formulate a prompt template that provides the necessary context and structure for a machine learning model (ML) model 522 to generate an order. In some embodiments, the prompt generator engine 526 can combine the outputs from speech-to-text (STT) converter 512 and the output from the facial information detector 514 to formulate a prompt template that provides the necessary context and structure for the machine learning model (ML) model 522 to generate an order.

In some embodiments, the prompt generator engine 526 of the bar service engine 520 is configured to generate an order prompt based at least in part on a received first user query from a first communication device associated with a first user and a received second user query from a second communication device associated with a second user. In one example, a first user query received from a first user is “I'd like a drink A,” and a second user query received from a second user is “me too.” The prompt generator engine 526 generates a first order prompt “the first user wants a drink A,” and a second order prompt “the second user wants a drink A” based on the received first user query and second user query.

In some embodiments, the bar service engine 520 transmits a notification of the generated order to a communication device for the respective user to review, modify, and/or confirm the order. For example, the communication device may receive the notification and convert the notification to a voice data in the identified language associated with the user and play the voice data to the user via an audio (e.g., a speaker, a headset, an earphone, etc.) associated with the communication device. Additionally, or alternatively, the notification may be a text that is displayed on a display screen of the communication device.

In some embodiments, when a communication device receives a user response indicative of a modification of the order (e.g., via the user interface (UI) engine 505 and/or the speech-to-text (STT) converter 512), the system 500 can generate a modified order by applying the machine learning (ML) model 522 to the received user response and the data repository 507. In some embodiments, the bar service engine 520 checks and delivers the status of the order to the respective communication device. In some embodiments, the bar service engine 520 generates and delivers a confirmation of the generated order to the user via a respective communication device. In some embodiments, the bar service engine 520 enters the order into a point-of-sale (POS) system which is coupled to the server 504.

In some embodiments, the server 504 includes a host engine 530 configured to generate a customer service item by applying a machine learning (ML) model 532 to a user's query/request and/or a user's data stored in a data repository including information associated with a user. In some examples, the host engine 530 can perform various functions of a casino host. In some examples, the host engine 530 can generate a customer service item including, for example, a dinner reservation, a show ticket, a room reservation, a bar service reservation, transportation, game playing assistance, promotions, etc., which can be tailored to the user's tastes and tier level.

In some embodiments, the host engine 530 receives the user query from the UI engine 504 and/or the STT converter 512 and generate a customer service item by applying a machine learning (ML) model 532 to the received user query and user's data stored a data repository 507. In some examples, the host engine 530 may generate a customer service item to escalate to a service staff in response to the received user query.

In some embodiments, the host engine 530 includes a prompt generator engine 536 configured to generate a request prompt based at least in part on the received user query. In some embodiments, the prompt generator engine 536 can preprocess the received user query by, for example, removing any noise or irrelevant information that may interfere with interpretation by the machine learning model. In some embodiments, the prompt generator engine 536 can apply natural language processing (NLP) and/or natural language understanding (NLU) techniques or related models to extract key information from the user query to determine the task or intent behind the user's query. Based on the identified task or intent, the prompt generator engine 536 can formulate a prompt template that provides the necessary context and structure for a machine learning model (ML) model 532 to generate a customer service item. In some embodiments, the prompt generator engine 536 can combine the outputs from speech-to-text (STT) converter 512 and the output from the facial information detector 514 to formulate a prompt template that provides the necessary context and structure for the machine learning model (ML) model 532 to generate a customer service item.

In some embodiments, the prompt generator engine 536 of the host engine 530 is configured to generate a request prompt based at least in part on a received first user query from a first communication device associated with a first user and a received second user query from a second communication device associated with a second user.

In some embodiments, the host engine 530 is configured to generate a solution to disputes between users (e.g., first and second players at the same wager table), between a player and a dealer, or between a user and the system, by applying the machine learning (ML) model 532 to one or more request prompt from one or more users, for example, a first request prompt from the first player and a second request prompt from the second player.

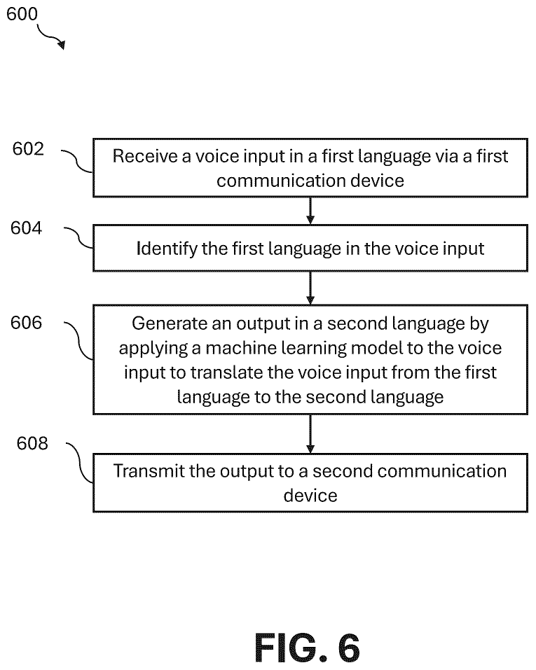

FIG. 6 is an example flow diagram depicting an illustrative method 600 of providing multi-language interactive services for players at wager tables, in accordance with some embodiments of the present disclosure. A general order for the steps of the method 600 is shown in FIG. 6. The method 600 may include more or fewer steps or may arrange the order of the steps differently than those shown in FIG. 6. In the illustrative aspect, the method 600 is performed by at least some components of a wager table management system (e.g., the system 100 in FIG. 1, the system 500 in FIG. 5). However, it should be appreciated that one or more steps of the method 600 may be performed by another devices, systems, or components of the systems.

The method 600 starts at operation 602. At operation 602, the system receives a voice input in a first language via a first communication device. At operation 604, the system identifies the first language in the voice input. At operation 606, the system generates an output in a second language by applying a first machine learning model to the voice input to translate the voice input from the first language to the second language. At operation 608, the system transmits the output in the second language to a second communication device.

In some embodiments, the system converts the voice input in the identified first language to a transcribed text in the second language. In some embodiments, the system converts the transcribed text in the second language to a voice output in the second language. In some embodiments, the system receives facial information detection data via the first communication device and generates at least one of a facial expression recognition output and a visual speech recognition output by applying a second machine learning model to the facial information detection data. In some embodiments, the system combines a first output of the voice input and at least one of the facial expression recognition output and the visual speech recognition output.

In some embodiments, the system receives a user query indicative of a user order via the first communication device, identifies the first language of the user query, generates an order applying a third machine learning model to the user query, and causes to present the order at a user interface. In some examples, the received user query can be a vocalized query and the system converts the vocalized query to a transcribed text. In some embodiments, the system generates an order prompt based at least in part on the user query. In some embodiments, In some embodiments,

In some embodiments, the system receives a user query indicative a customer service item via the first communication device, identifies the first language of the user query, generates the customer service item by applying a fourth machine learning model to the user query, and causes to deliver the customer service item to a user interface.

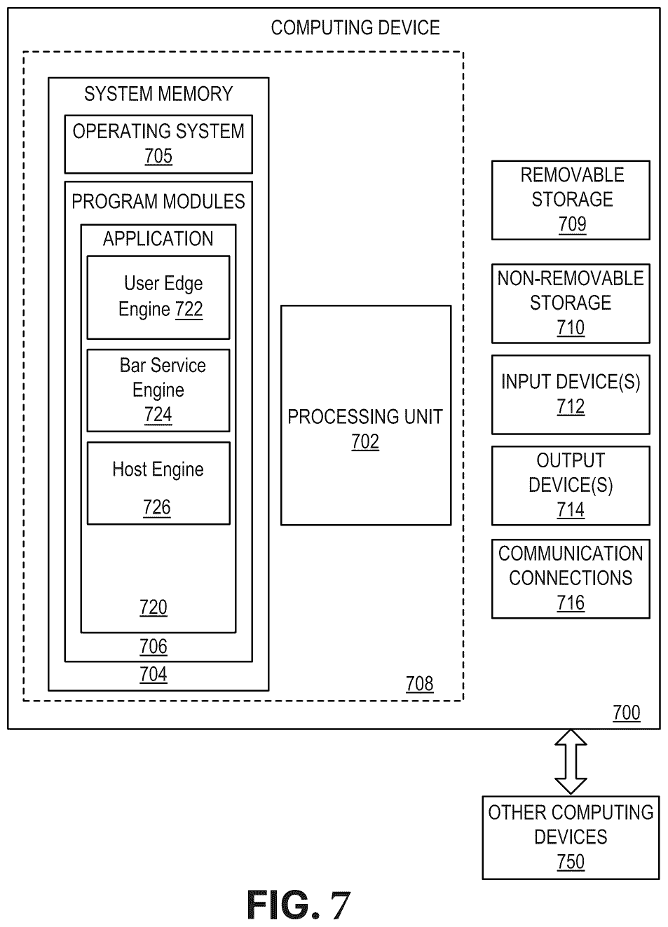

FIG. 7 is a simplified block diagram of a computing device 700, with which aspects of the present disclosure may be practiced. The computing device components described below may be suitable for the computing devices described above, including the computing device 222 and/or the server 224 in FIG. 2. The computing device 700 may include at least one processing unit 702 and a system memory 704. Depending on the configuration and type of computing device, the system memory 704 may include, for example, volatile storage (e.g., random access memory), non-volatile storage (e.g., read-only memory), flash memory, or any combination of such memories.

The system memory 704 may include an operating system 705 and one or more program modules 706 suitable for running software application 720, such as one or more components supported by the systems described herein. As examples, system memory 704 may store user edge engine or processor 722, bar service engine or processor 724, and/or host engine or processor 726. In some embodiments, the edge engine or processor 722, the bar service engine or processor 724, and the host engine or processor 726 can be or include the edge engine or processor 510, the bar service engine or processor 520, and the host engine or processor 530 in FIG. 5, respectively. The operating system 705, for example, may be suitable for controlling the operation of the computing device 700.

A basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 (e.g., application 720) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, and the like.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Some aspects of the disclosure may also be practiced using other technologies capable of performing logical operations such as, for example, AND, OR, and NOT, including but not limited to mechanical, optical, fluidic, and quantum technologies. In addition, some aspects of the disclosure may be practiced within a general-purpose computer or in any other circuits or systems.

The computing device 700 may also have one or more input device(s) 712 such as a keyboard, a mouse, a pen, a sound or voice input device, a touch or swipe input device, and the like. Output device(s) 714 such as a display, speakers, a printer, etc. may also be included. The aforementioned devices are examples and others may be used. The computing device 700 may include one or more communication connections 716 allowing communications with other computing devices 750. Examples of suitable communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Various modifications and additions can be made to the exemplary embodiments discussed without departing from the scope of the present disclosure. For example, while the embodiments described above refer to particular features, the scope of the present disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

We claim:

1. A wager table management system comprising:
one or more wager communication system, each wager communication system being couplable to a wager table and comprising:
a first communication device couplable to the wager table; and
a second communication device couplable to the wager table and communicatively coupled to the first communication device;
one or more memories having instructions stored thereon; and
one or more processors configured to execute the instructions and perform operations comprising:
receiving a voice input in a first language via the first communication device; and
generating an output in a second language by applying a first machine learning model to the voice input to translate the voice input from the first language to the second language.

2. The system of claim 1, wherein the generating an output further comprises:
converting the voice input in the first language to a transcribed text in the second language.

3. The system of claim 2, wherein the generating an output further comprises:
converting the transcribed text in the second language to a voice output in the second language.

4. The system of claim 1, wherein the operations further comprise:
receiving facial information detection data via the first communication device; and
generating at least one of a facial expression recognition output and a visual speech recognition output by applying a second machine learning model to the facial information detection data.

5. The system of claim 4, wherein the generating an output further comprises:
combining a first output of the voice input and at least one of the facial expression recognition output and the visual speech recognition output.

6. The system of claim 1, wherein the operations further comprise:
receiving a user query indicative of a user order via the first communication device;
identify the first language of the user query;
generating an order applying a third machine learning model to the user query; and
causing to present the order at a user interface.

7. The system of claim 6, wherein the operations further comprise:
generating an order prompt based at least in part on the user query; and
applying the third machine learning model to the order prompt.

8. The system of claim 6, wherein the receiving a user query further comprises receiving a vocalized query.

9. The system of claim 8, wherein the generating an order comprises converting the vocalized query to a transcribed text.

10. The system of claim 1, wherein the operations further comprise:
receiving a user query indicative a customer service item via the first communication device;
identifying the first language of the user query;
generating the customer service item applying a fourth machine learning model to the user query; and
causing to deliver the customer service item to a user interface.

11. A method of providing interactive wager services, the method comprising:
receiving a voice input in a first language via a first communication device;
identifying the first language in the voice input;
generating an output in a second language by applying a first machine learning model to the voice input to translate the voice input from the first language to the second language.

12. The method of claim 11, wherein the generating an output further comprises:
converting the voice input in the first language to a transcribed text in the second language.

13. The method of claim 12, wherein the generating an output further comprises:
converting the transcribed text in the second language to a voice output in the second language.

14. The method of claim 1, further comprising:
receiving facial information detection data via the first communication device; and
generating at least one of a facial expression recognition output and a visual speech recognition output by applying a second machine learning model to the facial information detection data.

15. The method of claim 14, wherein the generating an output further comprises:
combining a first output of the voice input and at least one of the facial expression recognition output and the visual speech recognition output.

16. The method of claim 11, further comprising:
receiving a user query indicative of a user order via the first communication device;
identifying the first language of the user query;
generating an order applying a third machine learning model to the user query; and
causing to present the order at a user interface.

17. The method of claim 16, further comprising:
generating an order prompt based at least in part on the user query; and
applying the third machine learning model to the order prompt.

18. The method of claim 16, wherein the receiving a user query further comprises receiving a vocalized query.

19. The method of claim 18, wherein the generating an order comprises converting the vocalized query to a transcribed text.

20. The method of claim 11, further comprising:
receiving a user query indicative of a customer service item via the first communication device;
identifying the first language of the user query;
generating the customer service item by applying a fourth machine learning model to the user query; and
causing to deliver the customer service item to a user interface.
